(19) United States
(12) Patent Application Publication
(10) Pub. No.: US 2025/0292494 A1
(43) Pub. Date: Sep. 18, 2025

(54) LIGHT TRANSPORT OFFLOADED PIPELINE

(71) Applicant: HUAWEI CLOUD COMPUTING TECHNOLOGIES CO., LTD., Gui Zhou Province (CN)

(72) Inventors: Nodir KODIROV, Kanata (CA); Yangyang ZHAO, Kanata (CA); Nima DAVARI, Kanata (CA); Li LI, Kanata (CA)

(73) Assignee: HUAWEI CLOUD COMPUTING TECHNOLOGIES CO., LTD., Gui Zhou Province (CN)

(21) Appl. No.: 18/606,923

(22) Filed: Mar. 15, 2024

(51) Int. Cl. G06T 15/50; G06T 15/00; G06T 15/06; G06T 17/20

(52) U.S. Cl. CPC G06T 15/506; G06T 15/005; G06T 15/06; G06T 17/205; G06T 2210/21

(57) ABSTRACT

Methods, apparatus, and systems for offloading light transport stages for rendering images are disclosed. Generating photorealistic images can be limited by available computing power, especially when processing light transport within the image. Embodiments of the present disclosure offload light transport computations to additional processing units, which may include servers of a server cluster or dedicated light transport processing units. In some embodiments, offloading is achieved by decoupling the light transport computations from subsequent shading computations through the use of a rudimentary shader. In some embodiments, optimizations for tiling, aggregating, and/or consolidating computations are used to overcome communication bottlenecks with the additional processing units. In other embodiments, the rudimentary shader and communication optimizations are used together to offload the light transport stage.

### CROSS-REFERENCE TO RELATED APPLICATIONS

This is the first application filed for the present invention.

### FIELD OF THE INVENTION

The present invention pertains to computer apparatus and methods and in particular to computer apparatus and methods for rendering images.

### BACKGROUND

Light transport can be modelled to render photorealistic images with computers. Ray tracing and photon mapping are the two leading light transport techniques. Both techniques model the interaction of light with an environment, such as through reflections and refractions, and can be feasibly implemented either online (i.e., in real time) or offline. These techniques can further be extended with path tracing, wherein light rays are recursively traced through multiple points of interaction along a light path.

Rendering photorealistic images, however, is highly computation intensive. Photorealism requires high frame rates, ultra-high-definition (UHD) resolutions, large numbers of samples per pixel, and a large recursive ray depth. Computer devices cannot typically meet these requirements. For example, a photorealistic, real-time application operating with a UHD display at 100 frames per second would require a ray tracing throughput of 10¹² rays per second (1 TR/s), while modern processing devices may be able to achieve a throughput of only 10¹¹ rays per second (100 GR/s). Furthermore, tight coupling between rendering stages for light transport and shading prevent the computations from being distributed over multiple processors.

Therefore, there is a need for methods and apparatus for computing light transport that obviate or mitigate one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide methods and apparatus for computing light transport.

A first aspect of the present disclosure is to provide an offload processing unit comprising a processor coupled to tangible, non-transitory processor-readable memory. The memory may have stored thereon instructions to be executed by to the processor to implement a method comprising: receiving, from a client-processing unit, a scene defining a scene geometry; tracing each of a plurality of light units in the scene to identify a respective one or more intersections with the scene geometry of each of one or more light units from among the plurality of light units; computing, for each of the one or more light units, in accordance with the respective one or more intersections, respective hit information; determining, in accordance with the respective hit information of each of the one or more light units, a set of scene hit information defining rudimentary shading for the scene; and sending, to the client processing unit, the set of scene hit information for shading the scene.

In some embodiments of the first aspect, the scene may have associated thereto a plurality of pixels each corresponding to a respective set of light units from among the plurality of light units, and the processor of the offload processing unit may include a plurality of processing sub-units. In these embodiments, the method may further comprise assigning, to each of the plurality of processing sub-units, a respective set of pixels from among the plurality of pixels for tracing each light unit of the corresponding set of light units in the scene.

In some embodiments of the first aspect, the scene geometry may have a plurality of mesh structures and the method may further comprise consolidating, when the respective one or more intersections of one of the one or more light units includes intersections with a set of mesh structures of the plurality of mesh structures, the respective one or more intersections into a compressed mesh structure. Each mesh structure of the set of mesh structures may be adjacent to at least one other mesh structure of the set of mesh structures.

In some embodiments of the first aspect, the scene geometry may define one or more surfaces, and each surface may be one of diffuse, rough specular, and smooth specular. The scene may have associated thereto a plurality of pixels each corresponding to a respective set of light units from among the one or more light units. The respective one or more intersections of the light units of each set of light units may include a respective same first intersection for the light units of the respective set of light units, and each light unit of the one or more light units may have associated thereto one or more respective path vertices each having associated thereto a respective path length. In these embodiments, determining, in accordance with the respective hit information of each of the one or more light units, the set of scene hit information defining rudimentary shading for the scene may include determining, for each pixel of the plurality of pixels, when the same first intersection of the respective set of light units occurs with one of the one or more surfaces of the scene geometry, at least one of: when the one surface is a diffuse surface, a respective irradiance; when the one surface is a rough specular surface, a respective radiance function; and when the one surface is a smooth specular surface, for each light unit of the respective set of light units, a respective sample path including the respective one or more path vertices, one or more respective groups of sample paths from among the sample paths of each light unit of the respective set of light units in accordance with the respective path lengths, a respective stochastically selected path for each of the one or more respective groups of sample paths, and a respective path radiance for each of the stochastically selected paths.

In some embodiments of the first aspect, the processor coupled to the tangible, non-transitory processor-readable memory may include a server cluster comprising a plurality of servers. In some of these embodiments, each server may include one or more graphics processing units. In some other embodiments, the processor coupled to the tangible, non-transitory processor-readable memory may include an application-specific integrated circuit.

In some embodiments of the first aspect, each light unit may be one of a light ray and a photon.

A second aspect of the present disclosure is to provide a method performed by an offload processing unit. The method may comprise: receiving, from the client processing unit, a scene defining a scene geometry; tracing each of a plurality of light units in the scene to identify a respective one or more intersections with the scene geometry of each of one or more light units from among the plurality of light units; computing, for each of the one or more light units, in accordance with the respective one or more intersections, respective hit information; determining, in accordance with the respective hit information of each of the one or more light units, a set of scene hit information defining rudimentary shading for the scene; and sending, to the client processing unit, the set of scene hit information.

In some embodiments of the second aspect, the scene may have associated thereto a plurality of pixels each corresponding to a respective set of light units from among the plurality of light units and the offload processing unit may include a plurality of processing sub-units. In these embodiments, the method may further comprise assigning, to each of the plurality of processing sub-units, a respective set of pixels from among the plurality of pixels for tracing each light unit of the corresponding set of light units in the scene.

In some embodiments of the second aspect, the scene geometry may have a plurality of mesh structures and the method may further comprise consolidating, when the respective one or more intersections of one of the one or more light units includes intersections with a set of mesh structures of the plurality of mesh structures, the respective one or more intersections into a compressed mesh structure, each mesh structure of the set of mesh structures being adjacent to at least one other mesh structure of the set of mesh structures.

In some embodiments of the second aspect, the scene geometry may define one or more surfaces, with each surface being one of diffuse, rough specular, and smooth specular. The scene may further have associated thereto a plurality of pixels each corresponding to a respective set of light units from among the one or more light units. The respective one or more intersections of the light units of each set of light units may include a respective same first intersection for the light units of the respective set of light units. Each light unit of the one or more light units may have associated thereto one or more respective path vertices each having associated thereto a respective path length. In these embodiments, determining, in accordance with the respective hit information of each of the one or more light units, the set of scene hit information defining rudimentary shading for the scene may include determining, for each pixel of the plurality of pixels, when the same first intersection of the respective set of light units occurs with one of the one or more surfaces of the scene geometry, at least one of: when the one surface is a diffuse surface, a respective irradiance; when the one surface is a rough specular surface, a respective radiance function; and when the one surface is a smooth specular surface, for each light unit of the respective set of light units, a respective sample path including the respective one or more path vertices, one or more respective groups of sample paths from among the sample paths of each light unit of the respective set of light units in accordance with the respective path lengths, a respective stochastically selected path for each of the one or more respective groups of sample paths, and a respective path radiance for each of the stochastically selected paths.

A third aspect of the present disclosure is to provide a method to be performed by an offload processing unit. The method may comprise obtaining a scene geometry defining one or more surfaces of a scene, with each surface being one of diffuse, rough specular, and smooth specular. The method may further comprise tracing a set of light units in the scene to identify a same first intersection of each light unit with one surface of the one or more surfaces of the scene, with each light unit having associated thereto one or more respective path vertices each having associated thereto a respective path length. The method may still further comprise determining, for the set of light units: when the one surface is a diffuse surface, an irradiance; when one surface is a rough specular surface, a radiance function; and when the one surface is a smooth specular surface, for each light unit of the respective set of light units, a respective sample path including the respective one or more path vertices, one or more respective groups of sample paths from among the sample paths of each light unit of the respective set of light units in accordance with the respective path lengths, a respective stochastically selected path for each of the one or more respective groups of sample paths, and a respective path radiance for each of the stochastically selected paths.

In some embodiments of the third aspect, the method may further comprise identifying, for each of the one or more surfaces, the respective surface as being one of diffuse, rough specular, and smooth specular in accordance with an approximated GGX specular model.

In some embodiments of the third aspect, determining, for the set of light units, when the one surface is a diffuse surface, the irradiance may include evaluating at least one indirect bounce for at least one light unit of the set of light units in accordance with an approximated GGX specular model. In some other embodiments, determining, for the set of light units, when the one surface is a rough specular surface, the radiance may include determining a respective sample radiance for each light unit of the set of light units, and a plurality of spherical harmonics coefficients in accordance with the respective sample radiances of each light unit of the set of light units. In some other embodiments, determining, for the set of light units, when the one surface is a rough specular surface, the radiance may include evaluating at least one indirect bounce of at least one light unit of the set of light units in accordance with an approximated GGX specular model. In still some other embodiments, determining, for the set of light units, when the one surface is a smooth specular surface, the respective stochastically selected path for each of the one or more groups of sample paths may include aggregating, for each of the one or more groups of sample paths, the sample paths of the respective group in accordance with an importance resampling technique.

A fourth aspect of the present disclosure is to provide a computing device comprising a processor coupled to tangible, non-transitory processor-readable memory. The memory may have stored thereon instructions to be executed by the processor to implement a method comprising obtaining a scene geometry defining one or more surfaces of a scene, with each surface being one of diffuse, rough specular, and smooth specular. The method may further comprise tracing a set of light units in the scene to identify a same first intersection of each light unit with one surface of the one or more surfaces of the scene, with each light unit having associated thereto one or more respective path vertices each having associated thereto a respective path length. The method may still further comprise determining, for the set of light units: when the one surface is a diffuse surface, an irradiance; when one surface is a rough specular surface, a radiance function; and when the one surface is a smooth specular surface, for each light unit of the respective set of light units, a respective sample path including the respective one or more path vertices, one or more respective groups of sample paths from among the sample paths of each light unit of the respective set of light units in accordance with the respective path lengths, a respective stochastically selected path for each of the one or more respective groups of sample paths, and a respective path radiance for each of the stochastically selected paths.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1A shows an example for rendering images in accordance with an architecture of the prior art.

FIG. 1B shows an example for rendering images in accordance with another architecture of the prior art.

FIG. 2 shows an architecture for offloading light transport for rendering images in accordance with an embodiment of the present disclosure.

FIG. 3 shows another architecture for offloading light transport for rendering images in accordance with an embodiment of the present disclosure.

FIG. 4A shows an example of a bottleneck in offloading light transport for rendering images.

FIG. 4B shows an example of another bottleneck in offloading light transport for rendering images.

FIG. 5 shows an example of a method for rudimentary shading, in accordance with an embodiment of the present disclosure.

FIG. 6 shows a schematic of an apparatus for schedule completion according to embodiments of the present disclosure.

FIG. 7 shows a schematic of an embodiment of an electronic device that may implement at least part of the methods and features of the present disclosure.

It will be noted that throughout the appended drawings, like features are identified by like reference numerals.

### DETAILED DESCRIPTION

Embodiments of the present disclosure are generally directed towards providing systems, apparatus, and methods for offloading computations associated with light transport (LT) in image rendering in order to provide additional computation capacity. Embodiments may include sending a portion or all of the LT computations from a client device seeking to render an image to one or more other processing units. In some embodiments, the one or more other processing units may be a server cluster or a dedicated processor such as an application-specific integrated circuit (ASIC). To offload the LT computations, embodiments may decouple them from shading computations by introducing a rudimentary shader (RuSh) within the LT computations. In some embodiments, offloading the LT computations may be enabled by optimizations for tiling, aggregating, and/or consolidating the computations.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to. The terms in each of the following sets may be used interchangeably throughout the disclosure: “image” and “scene”; “sample” and “light unit”; “bounce” and “intersection”.

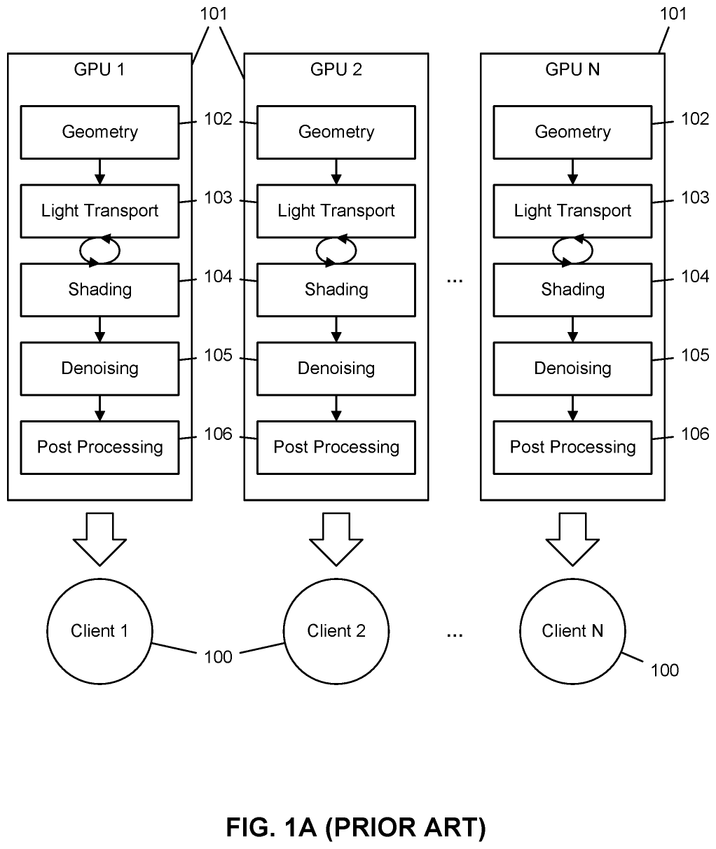

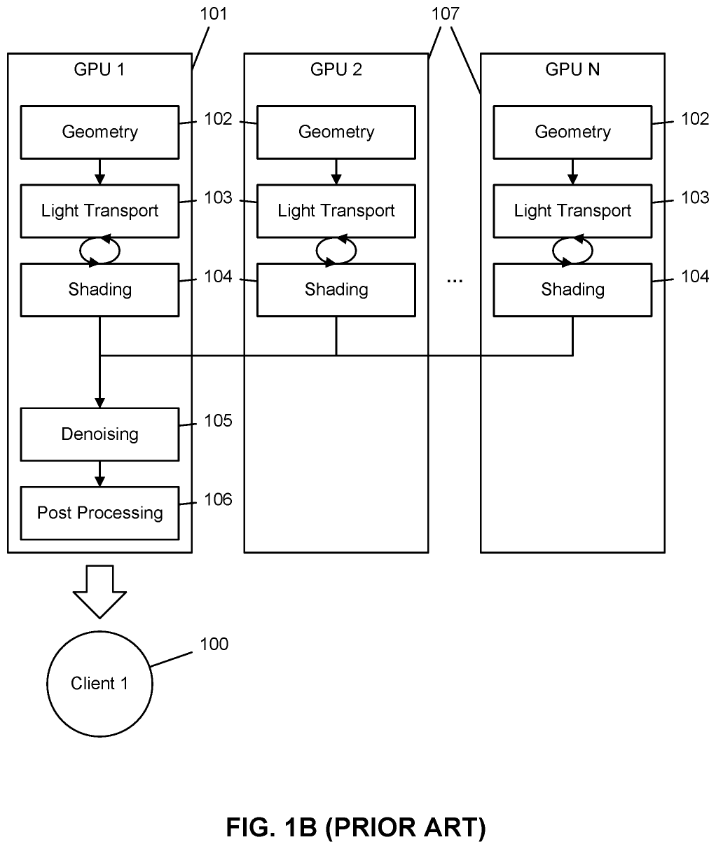

FIG. 1A shows an example of rendering images (or “scenes”) for N clients 100 in accordance with an architecture typical of the prior art. In FIG. 1A, each client 100 has a client processing unit 101 associated with it that performs the computations required to render a respective scene. In the example, each client processing unit 101 is depicted as a graphics processing unit (GPU). A plurality of stages is included in the computations for rendering a scene. To render a scene, each client processing unit 101 individually processes the following computation stages: geometry 102, LT 103, shading 104, denoising 105, and post-processing 106. The LT 103 and shading 104 stages are typically coupled such that one or more actions of each stage are iterated sequentially (indicated by circular arrows in FIG. 1A). Once a scene is rendered by one of the client processing units 101, it is provided to the respective client 100. In the example of FIG. 1A, each client processing unit 101 may have insufficient computational capacity to process the stages for rendering, especially for computing LT 103, which is typically the most computation intensive stage.

FIG. 1B shows an example of rendering scenes for one client 100 in accordance with another architecture typical of the prior art. In FIG. 1B, computations of the stages for geometry 102, LT 103, and shading 104 are distributed across a client processing unit 101 and N−1 distributed processing units 107. Each of the client processing unit 101 and N−1 distributed processing units 107 is depicted as a GPU; however, in some other examples they may be processing units on one server or distributed across multiple servers. Once the geometry 102, LT 103, and shading 104 stages are processed at each processing unit, the respective contributions are sent to the client processing unit 101 for completion of denoising 105 and post-processing 106 stages. Once a scene is rendered, it is then provided to the client 100. In FIG. 1B, the LT 103 and shading 104 stages are coupled, as described in relation to FIG. 1A. Although, the distributed processing units 107 add computation capacity for rendering the scene, the coupling between the LT 103 and shading 104 stages prevents the LT 103 stage from being offloaded separate from the shading 104 stage, which restricts computational throughput.

Embodiments of the present disclosure may provide sufficient computational capacity and throughput for rendering photorealistic scenes.

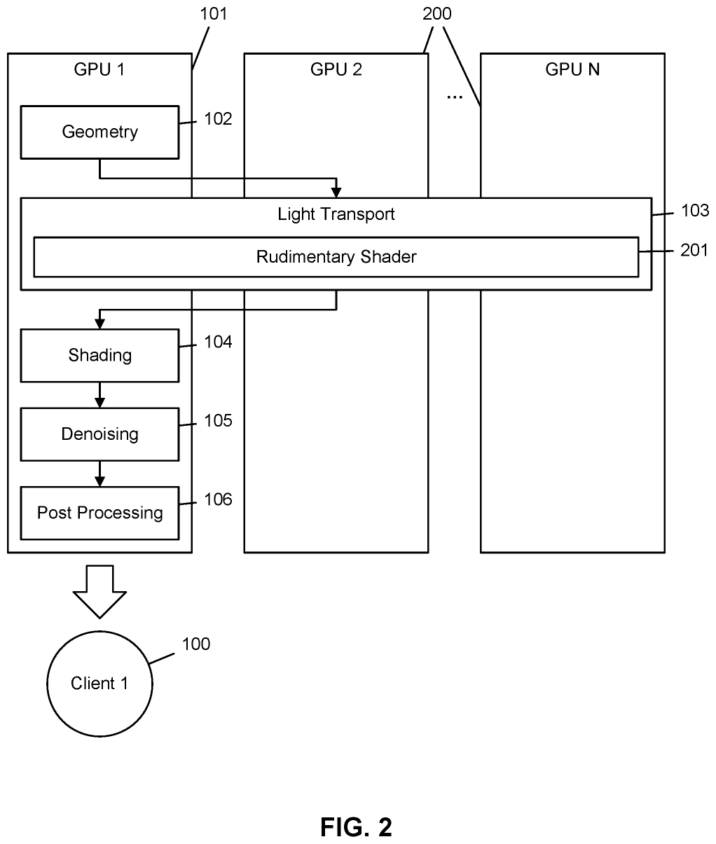

FIG. 2 shows an architecture for rendering a scene for a client 100 in accordance with an embodiment of the present disclosure. Here, the LT stage 103 may be offloaded, partially or wholly, from a client processing unit 101 to one or more offload processing units 200. Although each of the offload processing units 200 is depicted as one of N GPUs, they may each alternatively be one server of a server rack or server cluster, or a dedicated processor chip such as an ASIC (referred to herein as a light transport processing unit or LTPU). The remaining stages for computing geometry 102, shading 104, denoising 105, and post-processing 106 may be processed by the client processing unit 101.

To facilitate offloading, the scene may be initiated at the client processing unit 101 by completing the geometry stage 102 to define a scene geometry. The scene and/or scene geometry may be sent from the client processing unit 101 to each of the one or more offload processing units 200 for completion of the LT stage 103. The scene geometry may define one or more surfaces each having associated with it respective material attributes. The scene geometry may have mesh structures, which may define the surfaces of the scene. Mesh structures, may include, for example, cells such as triangles or tetrahedrons. The scene may have associated with it a plurality of pixels, which may correspond to pixels of a display, such as a monitor or screen, for visualizing the scene. The scene may be one frame of a sequence of frames for the scene, such as when rendering a movie or video game.

In embodiments of the present disclosure, offloading of the LT stage 103 may include offloading ray tracing, photon mapping, path tracing, a combination thereof, or other LT rendering techniques. It may further include offloading supplementary computations associated with these techniques. Each LT technique may include tracing a plurality of light units, such as light rays or photons, associated with the scene. Each pixel of the scene may have associated with it a respective set of light units from among the plurality of light units. Tracing may include, for example, determining respective paths of each light unit and identifying one or more respective intersections with the scene geometry of one or more light units of the plurality of light units. Each path of each light unit may have associated with it one or more respective path vertices, which each have an associated respective path length. Tracing may alternatively include mapping photons. For each of the one or more light units, respective hit information may be computed in accordance with the respective intersections of the respective light unit. In the context of the present disclosure, “hit information” refers to the intersection of a light unit with a surface in the scene. LT stage 103 may further include determining a set of scene hit information in accordance with the respective hit information of each light unit. The scene hit information may define rudimentary shading for the scene. The respective hit information of each light unit and the subsequent set of scene hit information may be computed using RuSh stage 201. The scene hit information may be returned to the client processing unit 101 for computing shading for the scene through the shading 104 stage.

In embodiments of the present disclosure, offloading of the LT stage 103 may be achieved by introducing the Rush stage 201 and performing light path aggregation within the RuSh stage 201. Without the Rush stage 201 and light path aggregation, the LT stage 103 may not be able to produce photorealistic images. In the context of the present disclosure the Rush stage 201 may be configured to perform rudimentary shading, which may include combining a simplified material model and light path caching. The RuSh stage 201 may provide pre-integrated and pre-filtered lighting on diffuse and rough specular surfaces, which may be input for the Shading stage 104. For smooth specular surfaces, the RuSh stage 201 may save and aggregate the paths generated by tracing of light units. These aggregated paths may be evaluated in the Shading stage 104. The Rush stage 201 may enable a sufficient amount of shading (i.e., rudimentary shading) to be processed during the computations of the LT stage 103 so that the LT stage 103 can be decoupled from the Shading stage 104.

The Rush stage 201 may generate light paths using one or more simplified material models. High-quality shading is postponed to the Shading stage 104, which may use the information generated by the Rush stage 201 for dynamic shading. By avoiding dynamic shader code in when material shading at the LT stage 103, instruction coherence may be ensured, which may result in high performance for implementation hardware. When aggregation is performed for smooth specular surfaces, the paths generated by tracing light units may be grouped and reordered. A resampled importance sampling (RIS) technique may then be applied, which may stochastically select a number of paths, P, from each group for high-quality shading at the Shading stage 104. P may be a pre-determined and adjustable number, typically set to 1, for example. This stochastic selection process may be weighted by radiances estimated for each light path. Each stochastically selected light path may be mathematically equivalent to all light paths of the corresponding group. This process may reduce sources of error to only deriving from the simplified material models used by the Rush stage 201, which may be controlled through selection of the simplified material model. With aggregation, the number of light paths that need to be shaded in Shading stage 104 may be greatly reduced; e.g., 100 light paths aggregated to 1 stochastically selected light path represents a reduction of 99%. Thus, the RuSh stage 201 may avoid costly high-quality material shading for all light paths and reduce computations needed for Shading stage 104.

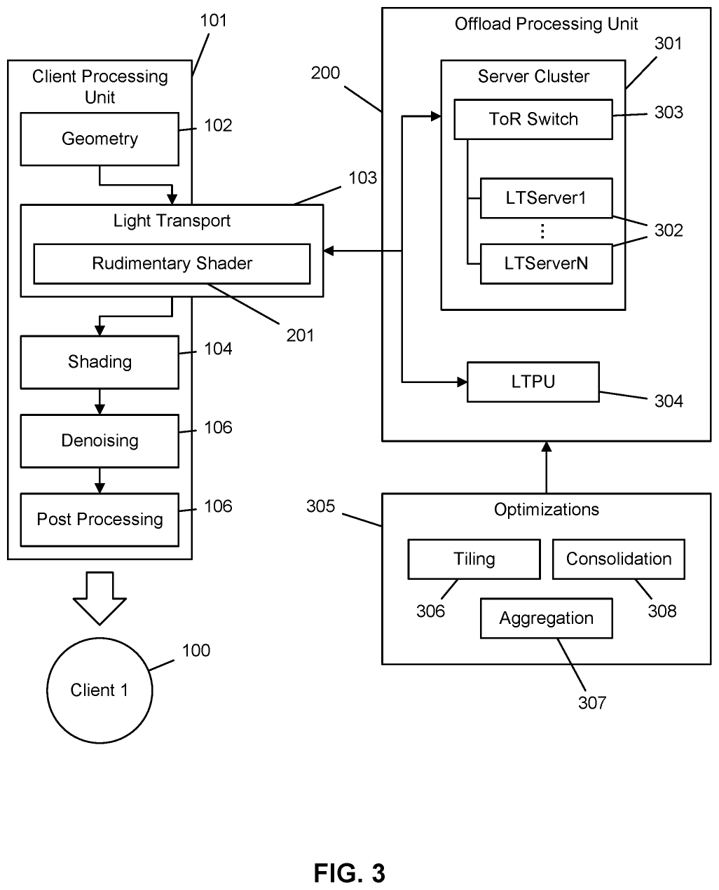

FIG. 3 shows another architecture for rendering a scene for a client 100 in accordance with an embodiment of the present disclosure. Here, the LT stage 103 is sent from the client processing unit 101 to an offload processing unit 200, which may comprise a plurality of processing sub-units. For example, the offload processing unit 200 may be a server cluster 301 comprising a plurality of servers 302 for computing LT (i.e., LTServers), where each LTServer 302 is a processing sub-unit. In this example, the client processing unit 101 may be a render server and may be coupled to the LTServers 302 through a top-of-rack (ToR) switch 303. As another example, the offload processing unit 200 may be an LTPU 304. The LTPU 304 may comprise a plurality of LT cores, where each LT core is a processing sub-unit. In some embodiments, the LT stage 103 may be partially offloaded such that the client processing unit 101 cooperatively processes the LT stage 103 with the offload processing unit 200. Offloading of the LT stage 103 may be enabled by one or more optimizations (optimization stages) 305 implemented through the offload processing unit 200. Optimizations 305 may include, for example, tiling 306, aggregation 307, and consolidation 308 of computations in the LT stage 103. These optimizations 305 are described in further detail hereinbelow.

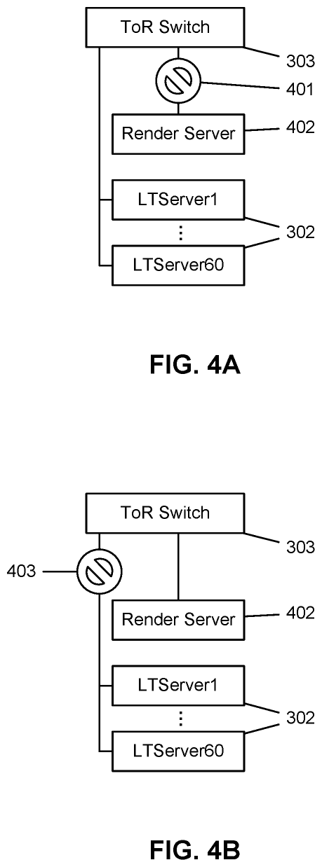

Offloading the LT stage 103, in accordance with embodiments of the present disclosure, can be hindered by one or more bottlenecks in network connections that couple the client processing unit 101 to the offload processing units 200. FIG. 4A shows an example of a first bottleneck 401. The example of FIG. 4A includes a render server 402 that is coupled to 60 LTServers 302 through a ToR switch 303. The first bottleneck 401 occurs between the render server 402 and the ToR switch 303. The first bottleneck 401 may occur when the render server 402 is offloading the LT stage 103 to the LTServers 302 or when the render server 402 is receiving hit information from the LTServers 302. For example, in offloading, the render server 402 may need to send for each light ray of a plurality of light rays: a scene identifier (1 byte), a camera position (12 bytes), and a direction (12 bytes). For 1 TR/s ray tracing, the network connections would need to operate at 200 terabits per second, whereas modern network links can typically provide around only 100 gigabits per second. As another example, each LTServer 302 may generate 11 gigabits per second of traffic when for 1 TR/s ray tracing with the 60 LTServers 302. The network traffic from the ToR switch 303 to the render server 402 would amount to 660 gigabits per second. Although the first bottleneck 401 has been described using an example of a server cluster 301, the first bottleneck 401 may similarly occur generally for a client processing unit 101 (e.g., the render server 402) connected to an offload processing unit (e.g., the LTServers 302) through a network switch (e.g., the ToR switch 303). FIG. 4B shows an example of a second bottleneck 403. This example, like that of FIG. 4A, includes a render server 402 that is coupled to 60 LTServers 302 through a ToR switch 303. The second bottleneck 403 occurs between the LTServers 302 and the ToR switch 303. The second bottleneck 403 may arise from large volumes of output from each of the LTServers 302. For example, each LTServer 302 may generate 3 terabits per second for 1 TR/s ray tracing with the 60 LTServers 302. Although the second bottleneck 403 has been described using another example of a server cluster 301, the second bottleneck 403 may similarly occur generally for a client processing unit 101 (e.g., the render server 402) connected to an offload processing unit (e.g., the LTServers 302) through a network switch (e.g., a ToR switch 303).

In some embodiments of the present disclosure, one or more optimizations 305 may be used to overcome bottlenecks in network connections that prevent offloading of the LT stage 103.

A first optimization 305 of some embodiments of the present disclosure is tiling 306. In the context of the present disclosure, tiling may be understood as including subdividing computations for the LT stage 103, which may be processed using parallel processing. This optimization addresses the first bottleneck 401 between the client processing unit 101 and the network switch (e.g., ToR switch 303). With tiling 306, the pixels of a scene may be partitioned among sub-processing units of the offload processing unit 200. Each sub-processing unit may be assigned a respective set of pixels from among the pixels of the scene for computing LT. With each sub-processing unit having an assigned set of pixels, and consequently the light units needing to be traced for that set of pixels, only a scene identifier and camera position may need to be sent to the sub-processing units for each frame of the scene. For example, for 36,000,000 pixels and 60 LTServers 302 forming the offload processing unit 200, each LTServer 302 may be assigned a respective set of 600,000 pixels. Then, for rendering each frame, 13 bytes may be sent to each LTServer 302. This would amount to about 10.4 kilobits per second.

A second optimization 305 of some embodiments of the present disclosure is aggregation 307. In the context of the present disclosure, aggregation may be understood as combining or accumulating information from multiple light paths to approximate the illumination of a point in a scene. This optimization addresses the second bottleneck 403 between the offload processing unit 101, or sub-processing units thereof, and the network switch (e.g., ToR switch 303). With aggregation 307, a set of light units associated with a pixel may be reduced into one or more aggregated light units. To begin, light units may be decomposed into a plurality of contributions. For example, light rays may be decomposed into contributions at vertices of their paths. The contributions of the set of light units may then be grouped, such as by path length, and then weighted according to a weighting function, such as by contribution size. A respective contribution may then be selected stochastically for each group. This may be done in accordance with a RIS technique. In this case, if the weighting function is the contribution size, the variance of RIS is mathematically equal to the combination of the contributions.

A third optimization 305 of some embodiments of the present disclosure is consolidation 308. This optimization addresses the first bottleneck 401 between a network switch and the client processing unit 101. With consolidation 308, when a light unit intersects with a plurality of adjacent mesh structures, the adjacent mesh structures may be consolidated into one consolidated mesh structure. Hit information for only the light unit intersecting with the consolidated mesh structure may be computed and sent to the client processing unit 101. Consolidation 308 may enable the amount of information sent to the client processing unit 101 to be compressed. For example, up to 84% of vertices of light unit paths may be compressed, leading to a compression of 84% in traffic on the network connection between the network switch (e.g., the ToR switch 303) and the client processing unit 101.

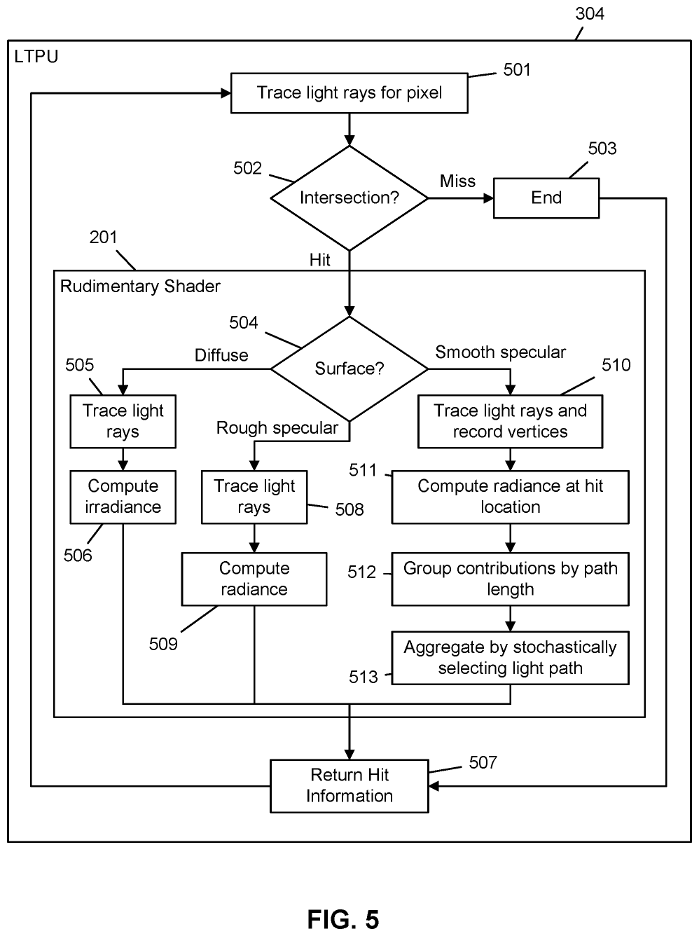

Offloading of the LT stage 103 may be provided in embodiments of the present disclosure by introducing a Rush stage 201. The RuSh stage 201 offers rudimentary shading as a simplified shader with lightweight computation yet sufficient accuracy to model all materials. The Rush stage 201 may enable recursive ray tracing within the offload processing unit 200. FIG. 5 shows an example of a method for rudimentary shading by a Rush stage 201 implemented on an LTPU 304, in accordance with an embodiment of the present disclosure. At action 501, a set of light rays respective to a pixel of a scene may be traced from a viewpoint for the scene. At action 502, the set of light rays may be evaluated for a first intersection (i.e., a primary hit) with a surface of one or more surfaces in the scene. If the light rays do not intersect with any surface in the scene, a miss may be recorded, tracing may end at action 503, and the miss may be returned as hit information to the client processing unit 101 from the LTPU 304, at action 507. If, however, the light rays do intersect with a surface, rudimentary shading by the Rush stage 201 may begin. At action 504, the surface may be evaluated to identify the surface as being one of diffuse, rough specular, and smooth specular. An approximate material model for the surface may be obtained using a GGX microfacet specular model or other models such as a Phong specular shading model. In embodiments described herein, the GGX specular model is used as a non-limiting example. A GGX specular model may further be used in identifying the type of surface. As an example, diffuse surfaces may have a roughness of about 1, rough specular surfaces may have a roughness between about 1 and 0.3, and smooth specular surfaces may have a roughness between about 0.3 and 0. The roughness ranges between 0 and 1, as described by microfacet models and as can be appreciated by a person skilled in the art.

If the surface is diffuse, at action 505, the light rays may continue to be traced and indirect bounces (e.g., second or third intersections) for each light ray may be evaluated. This may be done in accordance with the GGX specular model. At action 506, an irradiance (E) may be computed for the first intersection as the respective hit information for each of the light rays. The irradiance and location of the first intersection (x) may be included in a set of scene hit information returned to the client processing unit 101, at action 507.

If the surface is rough specular, at action 508, the light rays may continue to be traced and indirect bounces (e.g., second or third intersections) for each light ray may be evaluated. This may be done in accordance with the GGX specular model. For rough specular surfaces, light reflections may depend on the viewpoint and be low-frequency. At action 509, incident radiance (i.e., an incident sample radiance) at the first intersection may be computed for each light ray. A radiance function for the set of light rays may then be computed, which may be defined by a spherical harmonics representation or other spherical mixture model, such as a spherical gaussian model or a von Mises-Fisher (vMF) distribution model. The spherical harmonics representation may, for example, be a fourth order model having 16 coefficients. The location of the first intersection and radiance function may be included in the set of scene information returned to the client processing unit 101, at action 507.

If the surface is smooth specular, at action 510, the light rays may continue to be traced and indirect bounces (e.g., second or third intersections) for each light ray may be evaluated. Each highly specular subsequent bounce (xᵢ) may be recorded as a path vertex along with an associated sample radiance (Lᵢ), at action 511. Here, index i identifies a respective path vertex. A maximum number of path vertices, such as three, may be recorded for each light ray and/or path vertices may be recorded until the light ray intersects a light source or rough surface (i.e., a rough specular or diffuse surface) in the scene. The path vertices may define a sample path for each light ray. Aggregation 307, as described hereinabove, may be implemented for the light rays according to their path vertices and associated sample radiances. At action 512, the sample paths may be grouped according to the number of path vertices respective to each light ray. For example, if the maximum number of path vertices is three, then the sample paths may be grouped into three groups. At action 513, a respective stochastic path (i.e., a “stochastically selected path”) may be selected for each group of sample paths. This may be done using an RIS technique. A radiance (i.e., “path radiance”) may be calculated for each stochastic path and may correspond to the radiance at the last path vertex for that stochastic path. At action 507, the stochastic paths and associated radiance may be included in the set of scene information returned to the client processing unit 101. For three maximum path vertices, this information may be presented as {y₁, y₂, y₃, L₃}, {y₁, y₂, L₂}, and {y₁, L₁}.

The method shown in FIG. 5 may iterate by advancing from action 507 to action 501.

Embodiments of the present disclosure may be implemented using electronics hardware, software, or a combination thereof. In some embodiments, the invention may be implemented by one or multiple computer processors executing program instructions stored in memory. In some embodiments, the invention may be implemented partially or fully in hardware, for example using one or more field programmable gate arrays (FPGAs) or ASICs to rapidly perform processing operations. In some embodiments, an ASIC may be configured as an LTPU.

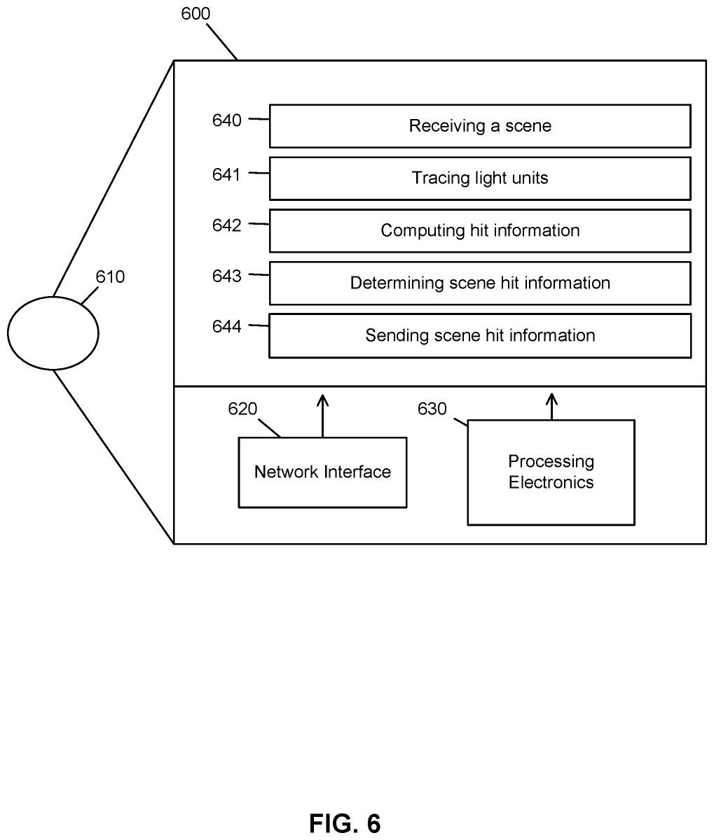

FIG. 6 shows an apparatus 600 for computing LT and/or rudimentary shading, according to embodiments of the present disclosure. The apparatus may be located at a node 610 of a network. The apparatus may include a network interface 620 and processing electronics 630. The processing electronics 630 may include a computer processor executing program instructions stored in memory, or other electronics components such as digital circuitry, including for example FPGAs and ASICs. The network interface 620 may include an optical communication interface or radio communication interface, such as a transmitter and receiver. The apparatus may include several functional components, each of which may be partially or fully implemented using the underlying network interface 620 and processing electronics 630. Examples of functional components may include modules for receiving 640 a scene, tracing 641 light units, computing 642 hit information, determining 643 scene hit information, and sending 644 scene hit information.

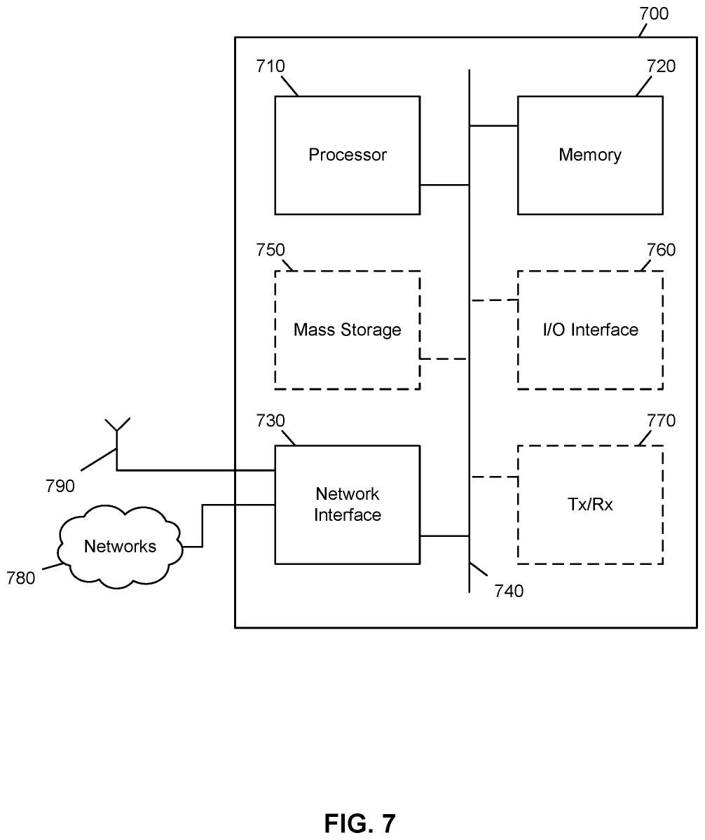

FIG. 7 shows a schematic diagram of an electronic device 700 that may perform any or all of the operations of the above methods and features explicitly or implicitly described herein, according to different embodiments of the present disclosure. For example, a computer equipped with network function may be configured as electronic device 700. The electronic device 700 may be used to implement the apparatus 600 of FIG. 6, for example. The electronic device 700 may further be used as part of an offload processing unit 200, for example.

As shown, the electronic device 700 may include a processor 710, such as a Central Processing Unit (CPU) or specialized processors such as a Graphics Processing Unit (GPU) or other such processor unit, memory 720, network interface 730, and a bi-directional bus 740 to communicatively couple the components of electronic device 700. Electronic device 700 may also optionally include non-transitory mass storage 750, an I/O interface 760, and a transceiver 770. According to certain embodiments, any or all of the depicted elements may be utilized, or only a subset of the elements. Further, the electronic device 700 may contain multiple instances of certain elements, such as multiple processors, memories, or transceivers. Also, elements of the hardware device may be directly coupled to other elements without the bi-directional bus 740. Additionally, or alternatively to a processor and memory, other electronics, such as integrated circuits, may be employed for performing the required logical operations.

The memory 720 may include any type of tangible, non-transitory memory such as static random access memory (SRAM), dynamic random access memory (DRAM), synchronous DRAM (SDRAM), read-only memory (ROM), any combination of such, or the like. The mass storage element 750 may include any type of tangible, non-transitory storage device, such as a solid state drive, hard disk drive, a magnetic disk drive, an optical disk drive, USB drive, or any computer program product configured to store data and machine executable program code. According to certain embodiments, the memory 720 or mass storage 750 may have recorded thereon statements and instructions executable by the processor 710 for performing any of the aforementioned method operations described above.

Network interface 730 may include at least one of a wired network interface and a wireless network interface. The network interface 730 may include a wired network interface to connect to a communication network 780 and may also include a radio access network interface 790 for connecting to the communication network 780 or other network elements over a radio link. The network interface 730 enables the electronic device 700 to communicate with remote entities such as those connected to the communication network 780.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. An offload processing unit comprising a processor coupled to tangible, non-transitory processor-readable memory, the memory having stored thereon instructions to be executed by the processor to implement a method comprising:
receiving, from a client-processing unit, a scene defining a scene geometry;
tracing each of a plurality of light units in the scene to identify a respective one or more intersections with the scene geometry of each of one or more light units from among the plurality of light units;
computing, for each of the one or more light units, in accordance with the respective one or more intersections, respective hit information;
determining, in accordance with the respective hit information of each of the one or more light units, a set of scene hit information defining rudimentary shading for the scene, and
sending, to the client processing unit, the set of scene hit information for shading the scene.

2. The offload processing unit of claim 1 wherein:
the scene has associated thereto a plurality of pixels each corresponding to a respective set of light units from among the plurality of light units;
the processor of the offload processing unit includes a plurality of processing sub-units; and
the method further comprises:
assigning, to each of the plurality of processing sub-units, a respective set of pixels from among the plurality of pixels for tracing each light unit of the corresponding set of light units in the scene.

3. The offload processing unit of claim 1 wherein:
the scene geometry has a plurality of mesh structures; and
the method further comprises:
consolidating, when the respective one or more intersections of one of the one or more light units includes intersections with a set of mesh structures of the plurality of mesh structures, the respective one or more intersections into a compressed mesh structure, each mesh structure of the set of mesh structures being adjacent to at least one other mesh structure of the set of mesh structures.

4. The offload processing unit of claim 1 wherein:
the scene geometry defines one or more surfaces, each surface being one of diffuse, rough specular, and smooth specular;
the scene has associated thereto a plurality of pixels each corresponding to a respective set of light units from among the one or more light units;
the respective one or more intersections of the light units of each set of light units includes a respective same first intersection for the light units of the respective set of light units;
each light unit of the one or more light units has associated thereto one or more respective path vertices each having associated thereto a respective path length; and
determining, in accordance with the respective hit information of each of the one or more light units, the set of scene hit information defining the rudimentary shading for the scene includes:
determining, for each pixel of the plurality of pixels, when the same first intersection of the respective set of light units occurs with one of the one or more surfaces of the scene geometry, at least one of:
when the one surface is a diffuse surface,
a respective irradiance;
when the one surface is a rough specular surface,
a respective radiance function; and
when the one surface is a smooth specular surface,
for each light unit of the respective set of light units, a respective sample path including the respective one or more path vertices,
one or more respective groups of sample paths from among the sample paths of each light unit of the respective set of light units in accordance with the respective path lengths,
a respective stochastically selected path for each of the one or more respective groups of sample paths,
and
a respective path radiance for each of the stochastically selected paths.

5. The offload processing unit of claim 1 wherein the processor coupled to the tangible, non-transitory processor-readable memory includes a server cluster comprising a plurality of servers, each server including one or more graphics processing units.

6. The offload processing unit of claim 1 wherein the processor coupled to the tangible, non-transitory processor-readable memory includes an application-specific integrated circuit.

7. The offload processing unit of claim 1 wherein each light unit is one of a light ray and a photon.

8. A method performed by an offload processing unit, the method comprising:
receiving, from a client processing unit, a scene defining a scene geometry;
tracing each of a plurality of light units in the scene to identify a respective one or more intersections with the scene geometry of each of one or more light units from among the plurality of light units;
computing, for each of the one or more light units, in accordance with the respective one or more intersections, respective hit information;
determining, in accordance with the respective hit information of each of the one or more light units, a set of scene hit information defining rudimentary shading for the scene; and
sending, to the client processing unit, the set of scene hit information.

9. The method of claim 8 wherein:
the scene has associated thereto a plurality of pixels each corresponding to a respective set of light units from among the plurality of light units;
the offload processing unit includes a plurality of processing sub-units; and
the method further comprises:
assigning, to each of the plurality of processing sub-units, a respective set of pixels from among the plurality of pixels for tracing each light unit of the corresponding set of light units in the scene.

10. The method of claim 8 wherein:
the scene geometry has a plurality of mesh structures; and
the method further comprises:
consolidating, when the respective one or more intersections of one of the one or more light units includes intersections with a set of mesh structures of the plurality of mesh structures, the respective one or more intersections into a compressed mesh structure, each mesh structure of the set of mesh structures being adjacent to at least one other mesh structure of the set of mesh structures.

11. The method of claim 8 wherein:
the scene geometry defines one or more surfaces, each surface being one of diffuse, rough specular, and smooth specular;
the scene has associated thereto a plurality of pixels each corresponding to a respective set of light units from among the one or more light units;
the respective one or more intersections of the light units of each set of light units includes a respective same first intersection for the light units of the respective set of light units;
each light unit of the one or more light units has associated thereto one or more respective path vertices each having associated thereto a respective path length; and
determining, in accordance with the respective hit information of each of the one or more light units, the set of scene hit information defining the rudimentary shading for the scene includes:
determining, for each pixel of the plurality of pixels, when the same first intersection of the respective set of light units occurs with one of the one or more surfaces of the scene geometry, at least one of:
when the one surface is a diffuse surface,
a respective irradiance;
when the one surface is a rough specular surface,
a respective radiance function; and
when the one surface is a smooth specular surface,
for each light unit of the respective set of light units, a respective sample path including the respective one or more path vertices,
one or more respective groups of sample paths from among the sample paths of each light unit of the respective set of light units in accordance with the respective path lengths,
a respective stochastically selected path for each of the one or more respective groups of sample paths,
and
a respective path radiance for each of the stochastically selected paths.

12. A method performed by an offload processing unit, the method comprising:
obtaining a scene geometry defining one or more surfaces of a scene, each surface being one of diffuse, rough specular, and smooth specular;
tracing a set of light units in the scene to identify a same first intersection of each light unit with one surface of the one or more surfaces of the scene, each light unit having associated thereto one or more respective path vertices each having associated thereto a respective path length; and
determining, for the set of light units:
when the one surface is a diffuse surface,
an irradiance;
when one surface is a rough specular surface,
a radiance function; and
when the one surface is a smooth specular surface,
for each light unit of the respective set of light units, a respective sample path including the respective one or more path vertices,
one or more respective groups of sample paths from among the sample paths of each light unit of the respective set of light units in accordance with the respective path lengths,
a respective stochastically selected path for each of the one or more respective groups of sample paths,
and
a respective path radiance for each of the stochastically selected paths.

13. The method of claim 12 further comprising:
identifying, for each of the one or more surfaces, the respective surface as being one of diffuse, rough specular, and smooth specular in accordance with an approximated GGX specular model.

14. The method of claim 12 wherein determining, for the set of light units, when the one surface is a diffuse surface, the irradiance includes:
evaluating at least one indirect bounce for at least one light unit of the set of light units in accordance with an approximated GGX specular model.

15. The method of claim 12 wherein determining, for the set of light units, when the one surface is a rough specular surface, the radiance includes:
determining:
a respective sample radiance for each light unit of the set of light units, and
a plurality of spherical harmonics coefficients in accordance with the respective sample radiances of each light unit of the set of light units.

16. The method of claim 12 wherein determining, for the set of light units, when the one surface is a rough specular surface, the radiance includes:
evaluating at least one indirect bounce of at least one light unit of the set of light units in accordance with an approximated GGX specular model.

17. The method of claim 12 wherein determining, for the set of light units, when the one surface is a smooth specular surface, the respective stochastically selected path for each of the one or more groups of sample paths includes:
aggregating, for each of the one or more groups of sample paths, the sample paths of the respective group in accordance with an importance resampling technique.
